(19) United States
(12) Patent Application Publication
(10) Pub. No.: US 2008/0256079 A1
(43) Pub. Date: Oct. 16, 2008

(54) LOAD-BASED TECHNIQUE TO BALANCE DATA SOURCES TO DATA CONSUMERS

(75) Inventors: Partha SAHA, Oakland, CA (US); Vijay RAGHUNATHAN, San Francisco, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/734,067

(22) Filed: Apr. 11, 2007

(51) Int. Cl. G06F 7/00

(52) U.S. Cl. 707/10

(57) ABSTRACT

A system and method is described to determine routing configurations to route data from data producers to data consumers. Each routing configuration corresponds to a time period during which data is routed from the data producers to the data consumers. Data is routed from the data producers to the data consumers according to previously determined data routing configurations during time periods prior to a current time period. Based at least in part on indications of the data load on the data consumers corresponding to actual data routing during the time periods prior to the current time period, a new data routing configuration is determined. During the current time period, data is routed from the data producers to the data consumers according to the determined new data routing configuration.

### BACKGROUND

There are many environments in which data producers provide data to data consumers. For example, when users interact with web properties provided by Yahoo! Inc., log data representing that user activity is provided from front end servers (with which the users are interacting) to data collectors (i.e., storage) in, for example, a data center. The data from the data collectors (in raw or processed form) may then be provided to data warehouses to be available for analysis.

It may be desirable in some circumstances to balance the data storage load, from data provided from the data providers, among particular data collectors. One conventional load-balancing scheme attempts to balance these loads by balancing the number of connections from the front end servers to each data collector. However, in many environments, some of the data producers may produce a relatively large amount of data whereas other data producers may be produce relatively much less data. The inventors have observed empirically in one operating environment that there can be an order of magnitude disparity in load among data collectors that are balanced simply by the number of connections from the data producers to each data collector.

### SUMMARY

A system and method is utilized to determine routing configurations to route data from data producers to data consumers based on historical loads. Each routing configuration corresponds to a time period during which data is routed from the data producers to the data consumers. Data is routed from the data producers to the data consumers according to previously determined data routing configurations during time periods prior to a particular time period. Based at least in part on indications of the data load on the data consumers corresponding to actual data routing during the time periods prior to the particular time period, a new data routing configuration is determined. During the particular time period, data is routed from the data producers to the data consumers according to the determined new data routing configuration.

For example, the data producers may be front-end servers and the data may be indications of user interactions with the front-end servers. By determining an allocation of data collectors to data producers based on an indication of historical load requirements of data producers, the load among data collectors can be relatively balanced.

### BRIEF DESCRIPTION OF THE DRAWINGS

FIG. 1 illustrates an architecture of a system in which a configuration server is provided to configure the connections between data producers and data consumers based on an indication of historical load requirements of the data producers.

FIG. 2 is a flowchart illustrating an example of processing within a configuration manager to configure paths between data producers and data consumers.

### DETAILED DESCRIPTION

The inventors have realized that, by determining an allocation of data collectors to data producers based on an indication of historical load requirements of data producers, the load among data collectors can be relatively balanced. Furthermore, in at least some examples, the connections between data producers and data consumers can be fairly stably allocated, such that the connections generally are persistent even between allocations.

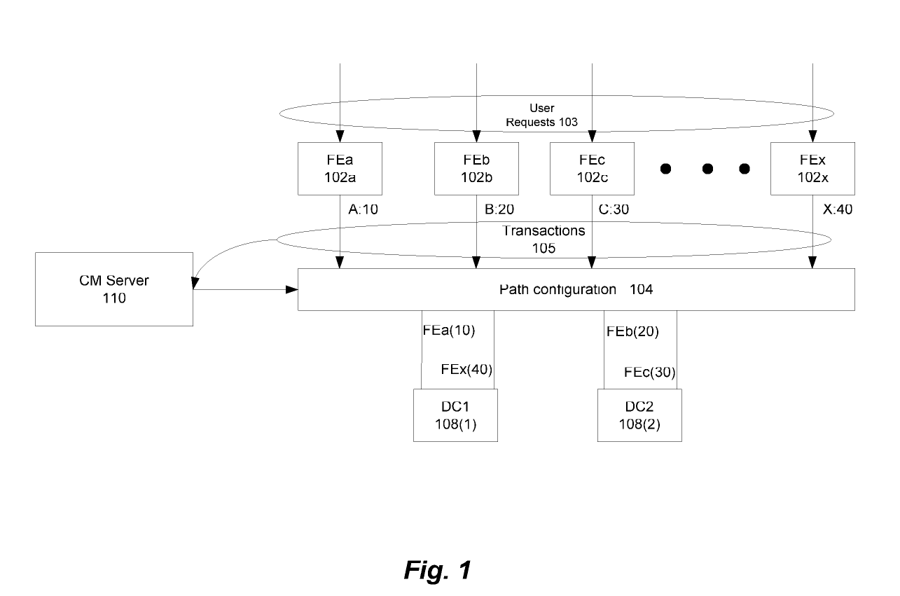

FIG. 1 illustrates an architecture of a system in which a configuration server is provided to configure the connections between data producers and data consumers based on an indication of historical load requirements of the data producers. Referring to FIG. 1, the front end web servers FEa 102a, FEb 102b, FEc 102c, . . . , FEx 102x are producing transaction data 105 based on incoming user requests 103. The transaction data 105 is provided to data collectors DC1 108(1) and DC2 108(2) via paths Pa 106a, Pb 106b, Pc 106c and Pd 106d. In general, there may be numerous data collectors and paths; a small number are shown in FIG. 1 for simplicity of illustration.

The data collectors may be, for example, machines in one or more data centers. A data center is a collection of machines that are co-located (i.e., physically proximally-located). The data centers may be geographically dispersed to, for example, minimize latency of data communication between front end web servers and the data collectors. Within a data center, the network connection between machines is typically fast and reliable, as these connections are maintained within the facility itself. Communication between end users and data centers, and among data centers, is typically over public or quasi-public networks (i.e., the internet).

Continuing with a discussion of FIG. 1, the path configuration 104 (i.e., configuration of front end web servers are connected to which data collectors) is under the control at least in part of a cluster manager server 110. More particularly, indications of produced transaction data are provided to a configuration manager (CM) server 110. In general, the indications are not the produced transaction data themselves but, rather, are an indication of the load (e.g., including data amount and timing) represented by the produced transactions. In one example, the indications include counters that indicate a number of events for a time period and the total size of those events. The CM server 110 is configured to process the transaction indications and an indication of the current path configuration 104 to determine a next path configuration 104.

In one example, the CM server 110 operates according to weights that have been assigned and/or determined for the various data producers. In general, the weights correspond to or are determined from the indications of produced transaction data. In general, during operation of the CM server 110, the weights for the data producers are processed by intelligently allocating the weights to the various data consumers to determine the path configuration 104.

We now discuss a particular simplistic example of determining the path configuration 104. In the example, as shown in FIG. 1, it is assumed that the weights for the data producers FEa 102a, FEb 102b, FEc 102c and FEx 102x have been determined to be 10, 20, 30 and 40, respectively. For the simplistic example, it is further assumed that there are no data producers being considered other than the data producers FEa 102a, FEb 102b, FEc 102c and FEx 102x.

In the example, it is assume that, initially, the path configuration 104 has not been “initialized” to no path. Therefore, the initial weights for the data consumers are DC1=0 and DC2=0. First, the list of data consumers is sorted in ascending order by weight. For the initial zero weights, we arbitrarily put the list of data consumers in order as {DC1, DC2}. The list of data producers is also sorted by weight in descending order. Thus, the initial list of data producers is {X:40, C:30, B:20, and A:10}.

In general, in accordance with the example, the data producers in the list are each considered in turn and, for each data producer, the data consumer node with the smallest weight (and still in the list of data consumers) is assigned to that data producer and is removed from the list of data consumers. Thus, the initial list of data consumers is {DC1:0; DC2:0}.

Returning now to the specifics of the example, data producer FEa 102a is first in the ascending order list of data producers. Thus, in the first iteration, with respect to data producer FEx 102a, the weight of 40 is associated with the data consumer having the smallest weight. In this case, since the weights of DC1 and DC2 are equal, we arbitrarily determine the data consumer having the smallest weight to be DC1. The weight of data producer FEx 102a is added to the weight of data consumer DC1 and, after the first iteration, the path configuration 104 is as follows:

DC1->{FEx}, total weight 40.

DC2->{ }, total weight 0.

In the second iteration, with respect to data producer FEc 102c, which is the next data producer in the list, the data consumer having the smallest weight is DC2 (since DC1 has a total weight of 40 and DC2 has a total weight of 0). The weight of data producer FEc 102c is added to the weight of data consumer DC2. Thus, after the second iteration, the path configuration 104 is as follows:

DC1->{FEx(40)}, total weight 40.

DC2->{FEc(30)}, total weight 30.

In the third iteration, with respect to data producer FEb 102b, which is the next data producer in the list, the data consumer having the smallest weight is again DC2 (since DC1 has a total weight of 40 and DC2 has a total weight of 10). The weight of data producer FEb 102b is added to the weight of data consumer DC2. Thus, after the third iteration, the path configuration 104 is as follows:

DC1->{FEx(40)}, total weight 40.

DC2->{FEc(30), FEb(20)}, total weight 50.

In the fourth iteration, with respect to data producer FEa 102a, which is the next data producer in the list, the data consumer having the smallest weight is now DC1 (since DC1 has a total weight of 40 and DC2 has a total weight of 50). The weight of data producer FEa 102a is added to the weight of data consumer DC1. Thus, after the fourth iteration, the path configuration 104 is as follows:

DC1->{FEx(40), FEa(10)}, total weight 50.

DC2->{FEc(30), FEb(20)}, total weight 50.

While the above simplistic example started with the weights for the data consumers all being zero, similar processing may be utilized in a non-initialization situation, where one or more of the data consumers already has a non-zero weight. For example, this processing may be carried out at regular or irregular time periods. For example, each time the processing is carried out, the processing may use data producer weights determined from indications of transactions occurring in the previous “M” hours. For example, M may be some number in the range of 24 to 36. In this way, the path configuration can be function of a “moving” statistic such as, for example, a moving average. In determining the weight for a data producer, the transaction indications may be weighted for particular time periods, such as being more heavily considered for more recent transactions.

It can seen that the processing by the configuration manager 104 can fairly allocate the load from the data consumers to the data producers. In some examples, the data consumers may be unequal in their ability or desire to process data from the data producers. In such a situation, the “total weight” during each iteration of the path configuration processing may be itself weighted. For example, if data consumer DC1 has half the processing capability of data consumer DC2, the total weight associated with data consumer DC2 may be doubled in the step of the processing where it is determined how to allocate the weight from additional data producers.

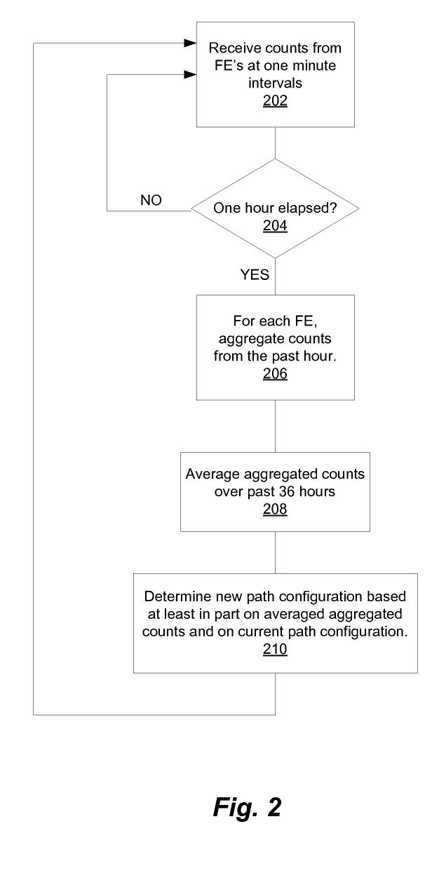

FIG. 2 is a flowchart illustrating an example of processing within a configuration manager to configure paths between Front End (FE) servers, which are data producers in this example, and data consumers (which may be, for example, disk storage to store data of transactions by users at the FE servers (such as, for example, viewing web pages).

At step 202, counts are received from the Front End (FE) servers. For example, as discussed above, the counts may be counts of a total number of events for that FE server in the past minute as well as the total size of those events. Other indications of the load (for that past minute) may also be provided. At step 204, it is determined if one hour has elapsed. In the FIG. 2 example, one hour is an interval at which the paths are reconfigured. If it is determined that one hour has not elapsed, then processing returns to step 202. Otherwise, processing proceeds to step 206.

At step 206, for each FE, the counts for that FE for the past hour are aggregated. More generally, in this manner, a measure of the load by that FE for the past hour is determined. At step 210, the aggregated counts for the last thirty six hours are aggregated. More generally, the counts used in determining the new path configuration include (and may, for example, even substantially include) the counts used in determining previous path configurations. In this way, the path configuration between the FE's and the data consumers exhibit a property of being slowly changing, perhaps even in the face of an abrupt change in the loads of the FE's. Meanwhile, processing continues at step 202.

It is noted that, in one example, the path configuration 104 determined by the configuration manager 110 is a “primary” configuration. That is, failover processing in the event of failure of a data consumer (or other need or desire to remove a particular data consumer from the path configuration) may be handled, in some examples, using standard failover processing. In one example of such standard failover processing, the path configuration may be in the context of virtual host names, and the standard failover processing may maintain a list of hostnames that may map to the virtual host names. When it is determined that a particular data consumer has failed, the standard failover processing then causes data that would otherwise be provided to the failed data consumer to be provided instead to another data consumer that maps to the virtual hostname associated with the failed data consumer.

According to various embodiments, transaction indications processed in accordance with the invention may be collected using a wide variety of techniques. For example, collection of data representing a click event and any associated activities may be accomplished using any of a variety of well known mechanisms for recording online events. Once collected, these data may be further processed before being provided to the configuration manager 110. The configuration manager 110 is illustrated in FIG. 3 as being a “server” but may correspond to multiple distributed devices and data stores.

The various aspects of the invention may also be practiced in a wide variety of network environments including, for example, TCP/IP-based networks, telecommunications networks, wireless networks, etc. In addition, the computer program instructions with which embodiments of the invention are implemented may be stored in any type of computer-readable media, and may be executed according to a variety of computing models including, for example, on a stand-alone computing device, or according to a distributed computing model in which various of the functionalities described herein may be effected or employed at different locations.

What is claimed is:

1. A method to determine routing configurations to route data from data producers to data consumers, comprising:
routing data from the data producers to the data consumers according to a first data routing configuration during a current time period;
based at least in part on indications of the data load on the data consumers corresponding to actual data routing, determining a second data routing configuration; and
thereafter, routing data from the data producers to the data consumers according to the second data routing configuration.

2. The method of claim 1, wherein determining the second routing configuration includes:
determining weights associated with the data producers based on the data load indications;
allocating the determined weights to the data consumers; and
determining the second routing configuration based on the allocated weights.

3. The method of claim 2, wherein:
determining weights associated with the data producers based on the data load indications includes:
determining at least one statistic based on the data load indications; and
determining the weights associated with the data producers based at least in part on the at least one statistic.

4. The method of claim 2, wherein:
determining the second routing configuration based on the allocated weights includes considering each of the data producers in a sequence and, based on a routing configuration determined thus far prior to considering a particular data producer, allocating the particular data producer to one of the data consumers without consideration for the data producers in the sequence not yet considered in determining the second routing configuration.

5. The method of claim 1, wherein:
the indications of the data load on the data consumers corresponding to actual data routing are indications of the data load on the data consumers during the current time period; and
the indications of the data load on the data consumers corresponding to actual data routing are indications of the data load on the data consumers during at least one time period other than the current time period, previous to the current time period, during which the data routing configuration is other than the current data routing configuration.

6. The method of claim 1, wherein:
the data producers are front-end web servers and the data being routed from the front-end web servers to the data consumers includes data indicative of user interaction with the front-end web servers.

7. A method to determine routing configurations to route data from data producers to data consumers, wherein each routing configuration corresponds to a time period, the method comprising:
routing data from the data producers to the data consumers according to previously determined data routing configurations during time periods prior to the current time period;
based at least in part on indications of the data load on the data consumers corresponding to actual data routing during the time periods prior to the current time period, determining a new data routing configuration; and
during the first time period, routing data from the data producers to the data consumers according to the determined new data routing configuration.

8. The method of claim 7, wherein:
determining a new data routing configuration includes
determining at least one statistic based on the data load indications corresponding to actual data routing during the time periods prior to the first time period; and
determining the weights associated with the data producers based at least in part on the at least one statistic.

9. The method of claim 7, wherein:
the time periods prior to the first time period includes a plurality of prior time periods; and
actual data routing during the plurality of prior time periods includes a different separate data routing corresponding to each of the plurality of prior time periods.

10. The method of claim 7, wherein:
the data producers are front-end web servers and the data being routed from the front-end web servers to the data consumers includes data indicative of user interaction with the front-end web servers.

11. A cluster manager configured to arrange a correspondence of data producers to data consumers of a cluster of data consumers, the cluster manager comprising:
a load indication receiver to receive indications of the data loads on the data consumers caused by data being provided to the data consumers from the data consumers during a current time period; and
a load indication processor configured to process the load indications and to determine, based thereon, a first routing configuration that indicates an appropriate correspondence of the data producers to the data consumers.

12. The cluster manager of claim 11, wherein the load indication processor is configured to:
determine weights associated with the data producers based on the data load indications;
allocate the determined weights to the data consumers; and
determine the second routing configuration based on the allocated weights.

13. The cluster manager of claim 12, wherein:
being configured to determine weights associated with the data producers based on the data load indications includes being configured to:
determine at least one statistic based on the data load indications; and
determine the weights associated with the data producers based at least in part on the at least one statistic.

14. The cluster manager of claim 12, wherein:
being configured to determine the second routing configuration based on the allocated weights includes being configured to consider each of the data producers in a sequence and, based on a routing configuration determined thus far prior to considering a particular data producer, allocate the particular data producer to one of the data consumers without consideration for the data producers in the sequence not yet considered in determining the second routing configuration.

15. The cluster manager of claim 11, wherein:
the indications of the data load on the data consumers corresponding to actual data routing are indications of the data load on the data consumers during the current time period; and
the indications of the data load on the data consumers corresponding to actual data routing are indications of the data load on the data consumers during at least one time period other than the current time period, previous to the current time period, during which the data routing configuration is other than the first data routing configuration.

16. The cluster manager of claim 11, wherein:
the data producers are front-end web servers and the data being routed from the front-end web servers to the data consumers includes data indicative of user interaction with the front-end web servers.

17. A computer program product to arrange a correspondence of data producers to data consumers of a cluster of data consumers, the computer program product comprising at least one computer-readable medium having computer program instructions stored therein which are operable to cause at least one computing device to:
receive indications of the data loads on the data consumers caused by data being provided to the data consumers from the data consumers during a current time period; and
process the load indications and to determine, based thereon, a first routing configuration that indicates an appropriate correspondence of the data producers to the data consumers.

18. The computer program product of claim 17 wherein the instruction to process the load indications include instructions to configure the at least one computing device to:
determine weights associated with the data producers based on the data load indications;
allocate the determined weights to the data consumers; and
determine the second routing configuration based on the allocated weights.

19. The computer program product of claim 18 wherein:
being configured to determine weights associated with the data producers based on the data load indications includes being configured to:
determine at least one statistic based on the data load indications; and
determine the weights associated with the data producers based at least in part on the at least one statistic.

20. The computer program product of claim 18, wherein:
being configured to determine the second routing configuration based on the allocated weights includes being configured to consider each of the data producers in a sequence and, based on a routing configuration determined thus far prior to considering a particular data producer, allocate the particular data producer to one of the data consumers without consideration for the data producers in the sequence not yet considered in determining the second routing configuration.

21. The computer program product of claim 17, wherein:
the indications of the data load on the data consumers corresponding to actual data routing are indications of the data load on the data consumers during the current time period; and
the indications of the data load on the data consumers corresponding to actual data routing are indications of the data load on the data consumers during at least one time period other than the current time period, previous to the current time period, during which the data routing configuration is other than the first data routing configuration.

22. The computer program product of claim 17, wherein:
the data producers are front-end web servers and the data being routed from the front-end web servers to the data consumers includes data indicative of user interaction with the front-end web servers.
